(19) United States
(12) Patent Application Publication
(10) Pub. No.: US 2016/0115427 A1
(43) Pub. Date: Apr. 28, 2016

(54) COMPOSITION USED TO REMOVE LABELS

(71) Applicant: ARKEMA FRANCE, Colombes (FR)

(72) Inventors: Paul Guillaume SCHMITT, Lescar (FR); Bernard MONGUILLON, Bayonne (FR)

(73) Assignee: Arkema France, Colombes (FR)

(21) Appl. No.: 14/896,804

(22) PCT Filed: Jun. 17, 2014
(86) PCT No.: PCT/FR2014/051498

§ 371 Date: Dec. 8, 2015

(30) Foreign Application Priority Data
Jun. 18, 2013 (FR) 1355678

(51) Int. Cl. C11D 7/06; B08B 3/10; C11D 3/43; C11D 7/50; C11D 3/04

(52) U.S. Cl. CPC C11D 7/06; C11D 7/5009; C11D 3/044; C11D 3/43; B08B 3/10

(57) ABSTRACT

The invention relates to the use of a composition for removing a label or labels from a labelled item, said composition comprising: between 1 and 3 wt. % of at least one organic or mineral base; between 2 and 10 wt. %, preferably between 3 and 8%, more preferably between 4 and 6%, of at least one water-miscible organic solvent; and water, the quantity of which is determined in such a way as to form the remainder of the total composition (100 wt. %). The invention also relates to the method for removing labels using said composition.

The subject of the invention is the use of a composition for removing labels affixed by gluing to various articles, and in particular to articles intended for recycling.

Many articles available on the market have a distinguishing mark. In order to enable their identification and/or to enhance them, these articles may be provided with one or more labels which are generally firmly attached to said articles by gluing. These labeled articles may be of any nature, such as wood, metal, glass, ceramic, stone, plaster, cement, concrete, composite materials, plastics, etc. Nonlimiting examples of such articles are bottles, packaging boxes and other receptacles or containers for liquid, solid or gaseous products.

In certain applications, these labels need to be removed, i.e. detached from the articles to which they were glued. This is the case, for example, for the articles intended for recycling, either as raw material or in order to be reused by means of the deposit system.

The deposit system enables in particular the recovery of the articles by recycling. Before being reused or put back into circulation, these articles need to be carefully cleaned of any residues and in particular require the removal of their labeling.

Many documents from the prior art already propose processes for cleaning labeled articles. Thus, patent applications FR 2 918 069 and WO 2012/062372 disclose such processes for cleaning by immersion in a hot basic aqueous solution. More specifically, application FR 2 918 069 discloses a hot-melt pressure sensitive adhesive (HMPSA) composition for manufacturing self-adhesive labels which may be detached by immersing the labeled articles in a basic aqueous solution having a pH equal to 12, at a temperature of 80° C. for at least 60 seconds. Application WO 2012/062372 discloses the use of a basic cleaning composition comprising an additive consisting of a mixture of surfactants, weak acids and/or salts at a temperature above 60° C. for at least one washing cycle of 120 seconds.

Documents DE 19642600 and WO 91/17236 describe the addition of very small amounts of an organic solvent to basic solutions for cleaning plastic articles in order to eliminate or prevent coloration and the appearance of odors. The organic solvents exemplified are alcohols, glycols, ketones, ethers, aldehydes, esters or carboxylic acids, without any effectiveness regarding the removal of labels being indicated.

Application U.S. Pat. No. 7,759,298 describes a composition comprising a non-halogenated organic solvent and glycerin for removing adhesive residues on hard surfaces. Application EP 844 301 teaches a process for cleaning recyclable plastic bottles using alkaline formulations containing phosphorus-based complexing agents and a surfactant. It is indicated that the labels are removed in a first step of the process.

It can only be observed that the prior art does not today provide any satisfactory solution for removing labels affixed to articles. The major difficulty of the processes where it is desired to remove glued labels and in particular the processes for recycling labeled articles is the effective removal of all traces of labels and of the adhesives which were used for the gluing thereof.

In order to improve the removal of the labels, mechanical processes are used for the articles in addition to the use of basic aqueous solutions. However, these mechanical processes are often aggressive and impair the general appearance of the articles, reducing the possible reuses thereof.

Currently, in the cleaning stations where the labels are removed, too many articles retain traces of adhesives and even large portions of labels after treatment with hot basic solutions. In order to overcome these problems, it could be envisaged to provide one or more additional washing cycles, a stronger concentration of the basic solution used, an increase in the temperature, etc. However, all these potential solutions do not make it possible to guarantee the expected result (effective removal of the labels, of the residues and of the traces of labels and of glues), without taking into account a loss of productivity and higher washing/cleaning costs, and also risks of damaging and even destruction or loss of articles.

There is therefore a significant need to obtain a process for cleaning labeled articles that satisfies manufacturers' expectations.

Surprisingly, the applicant has discovered, after various experiments and handling operations, that the combined use of a basic aqueous composition containing an effective and optimized amount of one or more water-miscible organic solvent(s) enables more effective cleaning and removal of the labels and of the adhesives from labeled articles during cleaning, in particular recycling, processes.

It is understood that a water-miscible solvent is a solvent capable of being soluble in water in any proportion. The terms “soluble in water”, “water-soluble” and “water-miscible” all have the same meaning in the account of the present invention.

The composition used for removing labels according to the present invention may be used in processes for cleaning labeled articles at temperatures below the temperatures customarily observed in the cleaning stations of the prior art. The contact time of the labeled articles with the composition of the present invention may also be reduced relative to the current systems. A mechanical action may optionally not be necessary or be less aggressive toward the recycled articles.

Thus, and according to a first aspect, the present invention relates to the use of a composition for the removal of label(s) from a labeled article, said composition comprising:
from 1% to 3% by weight of at least one organic or mineral base,
from 2% to 10% by weight of at least one water-miscible organic solvent, preferably from 3% to 8%, more preferably from 4% to 6%, and
water, the amount of which is determined so as to form the remainder of the total composition (100% by weight).

Unless expressly indicated otherwise, all the percentages expressed in the description of the present invention are percentages by weight. The numerical intervals that appear in the present description (percentage range, molar concentration range, temperature range, etc.) are understood to mean limits included.

The mineral or organic base(s) may be of any type known to a person skilled in the art and especially those commonly used in the field of compositions for removing label(s).

According to one preferred embodiment, the mineral or organic base(s) is (are) those that are miscible or at least partially miscible in the organic solvent/water mixture of the composition used within the context of the present invention.

When a mineral base is incorporated into the composition for removing label(s), this base is advantageously selected from alkali or alkaline-earth metal hydroxides, alkali or alkaline-earth metal salts and alkali or alkaline-earth metal hypochlorites, for example, and nonlimitingly, and preferably from sodium hydroxide, potassium hydroxide, lithium hydroxide, sodium carbonate, potassium carbonate and sodium hypochlorite.

When an organic base is incorporated into the composition for removing label(s), this base is advantageously selected from primary amines, secondary amines, tertiary amines, primary alkanolamines, secondary alkanolamines and tertiary alkanolamines. According to one preferred embodiment, the aforementioned organic bases may for example, and nonlimitingly, be selected from monoethanolamine, N-methylethanolamine, N-methyldiethanolamine, etc.

The mineral and/or organic base(s) is/are preferably present at a concentration of between 0.1 mol/L and 1.3 mol/L, preferably between 0.1 mol/L and 0.8 mol/L, more preferably between 0.2 mol/L and 0.7 mol/L.

In one option offered by the invention, the composition comprises from 0.2 mol/L to 0.7 mol/L of at least one mineral base.

According to one embodiment, said at least one organic solvent is an aprotic, preferably polar, water-soluble solvent. According to another embodiment, the boiling point at atmospheric pressure of said at least one organic solvent is above 25° C., preferably above 50° C., more preferably above 70° C.

According to yet another preferred embodiment of the invention, said at least one organic solvent is advantageously selected from acetone, ethyl acetate, acetonitrile, dimethylformamide, dimethoxyethane, dioxane, triethylamine, tetrahydrofuran, dimethyl sulfoxide, N,N-dimethylacetamide, N-methyl-2-pyrrolidone, N-ethyl-2-pyrrolidone, and N-octylpyrrolidone.

According to one very particularly preferred embodiment of the invention, said at least one organic solvent is selected from ethyl acetate, acetonitrile, dimethylformamide, dimethoxyethane, dioxane, dimethyl sulfoxide, N-methyl-2-pyrrolidone, N-ethyl-2-pyrrolidone, and N-octyl-2-pyrrolidone.

More preferably, the organic solvent is selected from acetonitrile, dimethylformamide, dimethoxyethane, dioxane, dimethyl sulfoxide, N-methyl-2-pyrrolidone, N-ethyl-2-pyrrolidone, and N-octyl-2-pyrrolidone.

Moreover, organic solvents that are soluble in the aqueous composition of use for the usage of the present invention, i.e. that do not form a biphasic system, are preferred. Indeed, a biphasic system might not be suitable for the applications targeted by the invention, in that such a biphasic system might not be compatible with the cleaning of the articles liable to contain food products.

As indicated above, the amount of solvent is generally between 2% and 10% by weight, preferably between 3% and 8%, more preferably between 4% and 6% by weight, relative to the total weight of the composition.

An amount of solvent of less than 2% would not enable the process according to the invention to remove the labels with a satisfactory contact time, which is understood to be a relatively short contact time, and a low operating cost. An amount of solvent of greater than 10% would represent too high an operating cost for the envisaged applications.

Quite preferably, said at least one organic solvent present in the composition that can be used to remove the labels from labeled articles is dimethyl sulfoxide (DMSO).

According to one preferred embodiment of the present invention, the latter relates to the use of a composition for the removal of label(s) from a labeled article, said composition being as defined above, and in which said at least one base is a mineral base selected from alkali and alkaline-earth metal hydroxides, and said at least one organic solvent is an aprotic polar solvent selected from ethyl acetate, acetonitrile, dimethylformamide, dimethoxyethane, dioxane, dimethyl sulfoxide, N-methyl-2-pyrrolidone, N-ethyl-2-pyrrolidone, and N-octyl-2-pyrrolidone.

The compositions as defined above, and in which said at least one base is sodium hydroxide and said at least one organic solvent is an aprotic polar solvent selected from acetonitrile, dimethylformamide, dimethoxyethane, dioxane, dimethyl sulfoxide, N-methyl-2-pyrrolidone, N-ethyl-2-pyrrolidone, and N-octyl-2-pyrrolidone are very particularly preferred.

For reasons in particular of cost but also of toxicity, the compositions described above and which are very particularly preferred comprise sodium hydroxide and at least one aprotic polar organic solvent selected from dimethoxyethane, dioxane and dimethyl sulfoxide, dimethyl sulfoxide being very particularly preferred.

According to one option offered by the invention, the composition also comprises at least one additive commonly used in such compositions and that is known to a person skilled in the art.

The additive(s) is/are preferably selected from antifoaming agents, foaming agents, anticorrosion agents, preservatives, sequestrants, surfactants, water hardening agents, water softening agents, fragrances and other additives conventionally used in the field of detergents, and also the mixtures of two or more thereof in any proportion.

The antifoaming agents are those conventionally used in the field of detergency and may for example be selected from mineral oils, fatty acids, esterified fatty acids, alcohols, silicones, organopolysiloxanes, poly(alkylene glycol)s, paraffins, waxes, microcrystalline waxes, etc. and also the mixtures of two or more thereof.

As regards the surfactants, these may be of any type, i.e. ionic (cationic, anionic or zwitterionic) or nonionic.

As examples of surfactants, mention may be made, nonlimitingly, of fatty amines, fatty amides, polyalkoxylated amines, polyalkoxylated amides, polyalkoxylated fatty amines, polyalkoxylated fatty amides, alkoxylated alcohols, alkoxylated alkyls and especially ethoxylated, propoxylated and/or butoxylated fatty alkyls and alcohols, glycol esters, glycerol esters, fatty acid triglycerides, fatty ester triglycerides, alkyl polyglycosides, phosphoric acid esters, alkoxylated alkylamines, betaines, amine oxides, and in particular amine oxides bearing a fatty alkyl chain, poly(alkylene oxide)s also known under the name polyoxyalkylene, where alkylene stands for ethylene, propylene or butylene, block copolymers of these poly(alkylene oxide)s, fatty alcohol alkoxylates, alkylphenol alkoxylates, fatty amine alkoxylates, fatty acid alkoxylates, carboxylates, in particular of fatty acids, alkyl sulfonates, alkylaryl sulfonates, alkyl sulfates, quaternary ammonium salts, quaternary ammonium salts of alkoxylated amines, etc. and also the mixtures of two or more thereof in any proportion.

Nonlimiting examples of surfactants which have demonstrated good results in terms of increase in effectiveness for removing labels are sorbitan esters and the alkoxylated, in particular ethoxylated, derivatives thereof, such as the Span and Tween compounds, sold in particular by Croda.

Generally, the surfactants and the mixtures of surfactants, of which the HLB (hydrophilic-lipophilic balance) value is between 7 and 20, limits included, preferably between 10 and 15, limits included, more preferably between 11 and 13, limits included, typically of which the HLB value is equal to around 12, are preferred.

When one or more additives are present in the composition, the amount of additive(s) is generally between 0.001% and 1% by weight, preferably between 0.01% and 1% by weight, more preferably between 0.05% and 0.5% by weight, relative to the total weight of the composition.

The compositions used for removing the labels present on articles, as indicated above, may be prepared according to any means known per se, for example by simple mixing of the ingredients included in said composition, with agitation, and at ambient temperature. A person skilled in the art will know how to determine the optional order of the compounds to be added, depending on the current risks. It is for example preferable to add said at least one base to water and not vice versa. It would not be outside the scope of the invention to slightly heat the components in order to ensure a better homogeneity or a shorter preparation time.

The composition according to the invention is thus useful for removing labels glued by adhesives to various types of articles as indicated above.

The labeled articles may be of any type and particularly those intended for recycling and which need to be cleaned before being reused, the cleaning operation comprising the step of removing the labels present on said articles. These articles may be of domestic or industrial use, and may be made of wood, metal, glass, ceramic, stone, plaster, cement, concrete, composite materials, plastics, etc. One very particularly preferred example of such articles are bottles and more particularly glass bottles intended for recycling (deposit system).

The use according to the present invention is not limited to the removal of labels, but also to the removal of any type of film glued to a hard support, and for example to the removal of bills of any size, of posters, of wallpapers, etc.

All these articles generally and usually contain one or more labels for the identification of said articles or of the products that they contain. These labels are usually based on paper, but also based on plastic-coated paper or based on polymer films.

The aforementioned labels are generally firmly attached to the articles to which they are affixed by means of an adhesive. For this purpose, the adhesives used are adapted to the nature of the article but also of the label that must be glued. Thus, the adhesives may themselves be of very diverse natures, and are those commonly used in the field of glueing labels and preferably are adhesives derived from animal proteins, derived from plants, but may also be synthetic adhesives.

The adhesives derived from animal proteins may for example be glues based on casein, gelatins and/or albumin. The adhesives derived from plants may for example be glues based on fecula, starch, dextrin, cellulose, lignin and alginate, but also glues based on natural gums, such as gum arabic, etc.

The synthetic adhesives may themselves be based on thermoplastic or thermosetting resins, based on polymer compounds such as polyacetates, polyacrylics, polyacrylates, polystyrenes, polyacrylonitriles, polyesters, phenolic resins, etc.

According to another aspect, the invention also relates to a process for the removal of a label affixed by gluing to an article, said process comprising at least the following steps:
a) optional heating of at least one composition according to the invention,
b) removal of said label by bringing said at least one composition into contact with at least the part of the labeled article comprising said label,
c) auxiliary and/or complementary removal of said label by mechanical action,
d) optional rinsing and optional drying of said article, and
e) recovery of said article.

The process for removing labels from labeled articles according to the invention may thus comprise at least one step of heating the composition, followed by at least one step of bringing at least the part of the labeled article comprising the label and said composition into contact, followed by or together with auxiliary steps of assisting or complementing the removal of the labels by mechanical action, optionally with the aid of abrasive rollers or brushes, followed at least by a step of rinsing and drying said article(s).

The boiling point of the solvent should be taken into consideration in the choice of the solvent, in that it is understood that a solvent having a boiling point below the temperature for heating the composition for the use according to the invention is not chosen. It is also understood that the higher the temperature, the more effective the label removal process. Thus, the appropriate temperature will be chosen as a function of the contact time between the label and the composition, of the boiling point of the organic solvent and of the energy associated with the heating of the composition, taking into consideration the overall cost of the process. Thus, the composition is preferably heated according to the process of the invention at a temperature between 15° C. and either the boiling point of the solvent or the boiling point of water, when considering the lowest boiling point, upper limit included.

More preferably, this temperature is between 15° C. and a temperature 5° C., preferably 10° C., and more preferably 20° C. lower than either the boiling point of the solvent or the boiling point of water, when considering the lowest boiling point.

In one preferred embodiment of the above process, the heating step a) is carried out at a temperature between 15° C. and 100° C., preferably between 20° C. and 90° C., more preferably still between 20° C. and 80° C., limits included.

The contacting step b) may be of any type known to a person skilled in the art, and for example and non-limitingly may be by partial or complete immersion of the article in said composition, by flow of the composition over all or part of the surface of the article comprising the label, by spraying and/or sprinkling and/or projecting the composition over all or part of the surface of the article comprising the label, etc. It is clearly understood that the step b) may be carried out one or more times depending on the nature of the label, of the adhesive, of the article, of the temperature of the composition and of the contact time. Thus the step b) may be carried out more than once, more than twice or even more, but is generally carried out once, twice, three times or four times.

The step b) of bringing the labeled surface into contact with the composition may be preceded by and/or followed by and/or carried out simultaneously with the step c) that consists of an auxiliary step of physical removal of the label. This step c) may also be carried out with any physical means known per se, such as, and nonlimitingly, at least one brush, scraper, mechanical agitation of the medium, etc., and also combinations of these means.

The mechanical agitation of the medium is particularly advantageous when the labeled article is immersed in the composition. This agitation may be effectively obtained with the aid of a mechanical (propeller, blade, etc.) agitator and/or by more or less violent bubbling of a gas (such as air or inert gas) into the immersion bath comprising the composition used for removing the label.

The labeled articles are generally brought into contact (step b) with the label-removing composition for a time that may vary from 1 second to several hours, preferably from 1 second to 240 minutes, preferably from 1 second to 60 minutes, more preferably from 1 second to 15 minutes, and usually from 1 second to 5 minutes, typically from 1 second to 60 seconds.

The use according to the invention of the compositions for removal of the labels from labeled articles (in recycling processes) is generally carried out in treatment stations comprising at least one tank comprising the label-removing composition, and optionally at least one mechanical means. Typically, the process of the invention may be carried out in manual or automated cleaning stations comprising washing tanks in which the articles from which it is desired to remove the labels are completely or partially immersed, and/or comprising one or more series of rotatable brushes in order to carry out an auxiliary and/or complementary removal of the labels by mechanical action.

Finally, the article stripped of its label may be rinsed with any type of suitable rinsing agent, generally water, and then optionally stripped of the traces of the rinsing agent, in particular dried, according to any type of means known to a person skilled in the art.

The following examples serve to illustrate the present invention, without however introducing any limitation thereto.

### EXAMPLES

Series of three labeled glass bottles are dipped on three successive occasions in a label-removing composition at ambient temperature (25° C.). The immersion time for each dip is estimated at 1 second. These immersion steps are followed by an auxiliary step of removal of the labels by mechanical means, in these examples with the aid of a small scraper.

The effectiveness of removal of the labels is determined by the amount of label and of residues of glue that remain on the wall of the bottles. This amount is expressed as a surface area of residues relative to the total surface area of the label present before the removal treatment.

The compositions tested are the following:
Composition A (reference): sodium hydroxide (NaOH)/water, 2%/98%, by weight;
Composition 1 (comparative): NaOH/DMSO/water, 2%/1.5%/96.5%, by weight;
Composition 2 (according to the invention): NaOH/DMSO/water, 2%/5%/93%, by weight;
Composition 3 (according to the invention): NaOH/DMSO/water, 2%/10%/88%, by weight.

The averages of each series of results corresponding to the effectiveness of removal of the labels as a function of the various cleaning compositions tested are presented in table 1 below.

TABLE 1

| Composition tested | % of residues |
|---|---|
| Composition A | 25% |
| Composition 1 | 25% |
| Composition 2 | <10% |
| Composition 3 | <10% |

These results show that the action of an alkaline solution alone does not make it possible to obtain satisfactory results in terms of removal of labels. The addition of a small amount of an aprotic polar solvent to this alkaline solution does not lead to satisfactory results either. On the other hand, above 2% by weight, the effectiveness increases substantially, thus demonstrating the specific action of the organic solvent added. In addition, an increase in the amount of organic solvent added does not result in a significant improvement of the effectiveness of removal of the labels.

Tests aiming to demonstrate the effect of the presence of surfactant in the compositions of the present invention were carried out using Composition 2 prepared above, to which various concentrations of surfactant(s) were added.

The surfactants used are the following:
Tween 20 (Croda), HLB=16.7;
Tween 20 (72.84 vol. %, Croda)/Span 20 (27.16 vol. %, Croda), HLB=14.5;
Tween 20 (41.98 vol. %, Croda)/Span 20 (58.02 vol. %, Croda), HLB=12;
Span 20 (Croda), HLB=8.6;
   at concentrations of 1000 ppm vol., and 5000 ppm vol.

The results are represented in table 2 below, where the increase in effectiveness relative to Composition 2 is graded “+”, “++” and “+++”, respectively denoting an “improvement”, a “great improvement” and a “very significant improvement”.

TABLE 2

| Composition | | Amount of | Effective- |
|---|---|---|---|
| tested | Surfactant added | surfactant added | ness |
| Composition 2 | — | — | — |
| Composition 2 | Tween 20 | 1000 | + |
| Composition 2 | Tween 20 (72.84%) + | 1000 | ++ |
| | Span 20 (27.16%) | | |
| Composition 2 | Tween 20 (41.98%) + | 1000 | ++ |
| | Span 20 (58.02%) | | |
| Composition 2 | Tween 20 | 5000 | ++ |
| Composition 2 | Tween 20 (72.84%) + | 5000 | ++ |
| | Span 20 (27.16%) | | |
| Composition 2 | Tween 20 (41.98%) + | 5000 | +++ |
| | Span 20 (58.02%) | | |

The present invention therefore offers a simple and effective solution for the removal of labels glued to hard surfaces, without requiring unreasonable amounts of organic solvents and therefore makes it possible to offer an effective and more environmentally friendly process.

1. A method for removing label(s) from a labeled article, comprising using a composition comprising:
from 1% to 3% by weight of at least one organic or mineral base,
from 2% to 10% by weight of at least one water-miscible organic solvent, and
water, the amount of which is determined so as to form the remainder of the total composition (100% by weight).

2. The method as claimed in claim 1, wherein said at least one organic solvent is an aprotic water-soluble solvent.

3. The method as claimed in claim 1, wherein said at least one organic solvent has a boiling point at atmospheric pressure above 25° C.

4. The method as claimed in claim 1, wherein said at least one organic solvent is selected from the group consisting of acetone, ethyl acetate, acetonitrile, dimethylformamide, dimethoxyethane, dioxane, triethylamine, tetrahydrofuran, dimethyl sulfoxide, N,N-dimethylacetamide, N-methyl-2-pyrrolidone, N-ethyl-2-pyrrolidone, and N-octylpyrrolidone.

5. The method as claimed in claim 1, wherein said at least one organic solvent is dimethyl sulfoxide.

6. The method as claimed in claim 1, wherein said at least one base is a mineral or organic base selected from the group consisting of alkali and alkaline-earth metal hydroxides, alkali and alkaline-earth metal salts, alkali and alkaline-earth metal hypochlorites, primary amines, secondary amines, tertiary amines, primary alkanolamines, secondary alkanolamines and tertiary alkanolamines.

7. The method as claimed in claim 1, wherein said at least one base is a mineral base selected from the group consisting of sodium hydroxide, potassium hydroxide and sodium hypochlorite.

8. The method as claimed in claim 1, wherein the composition comprises sodium hydroxide and at least one aprotic polar organic solvent selected from the group consisting of dimethoxyethane, dioxane and dimethyl sulfoxide.

9. The method as claimed in claim 1, wherein the composition also comprises between 0.001% and 1% by weight, relative to the total weight of the composition, of at least one additive.

10. The method as claimed in claim 9, wherein said at least one additive comprises a selected surfactant or a mixture of surfactants, of which the HLB (hydrophilic-lipophilic balance) value is between 7 and 20, limits included.

11. The method as claimed in claim 9, wherein said at least one additive comprises a surfactant or a mixture of surfactants selected from the group consisting of sorbitan esters and the alkoxylated derivatives thereof.

12. A process for the removal of a label affixed by gluing to an article, said process comprising at least the following steps:
a) optional heating of at least one composition comprising:
from 1% to 3% by weight of at least one organic or mineral base,
from 2% to 10% by weight of at least one water-miscible organic solvent, and
water, the amount of which is determined so as to form the remainder of the total composition (100% by weight),
a) removing said label by bringing said at least one composition into contact with at least the part of the labeled article comprising said label,
b) auxiliary and/or complementary removal of said label by mechanical action,
c) optional rinsing and optional drying of said article, and
d) recovering said article.

13. The process as claimed in claim 12, wherein the step of heating said composition is carried out at a temperature between 15° C. and 100° C., limits included.

14. The process as claimed in claim 12, wherein the step b) of bringing into contact with the label-removing composition is carried out for a time that varies from 1 second to several hours.

15. The method of claim 1, wherein the composition is comprised of from 3% to 8% by weight of the at least one water-miscible organic solvent.

16. The method of claim 1, wherein the at least one organic solvent has a boiling point at atmospheric pressure above 50° C.

17. The method of claim 1, wherein said at least one organic solvent is a polar water-soluble solvent.

18. The method of claim 1, wherein the composition additionally comprises a selected surfactant or a mixture of surfactants, of which the HLB (hydrophilic-lipophilic balance) value is between 10 and 15, limits included.

19. The method of claim 1, wherein the composition additionally comprises between 0.01% and 1% by weight, relative to the total weight of the composition, of at least one surfactant or a mixture of surfactants, of which the HLB (hydrophilic-lipophilic balance) value is between 11 and 13, limits included.

20. The process of claim 12, wherein the composition additionally comprises between 0.001% and 1% by weight, relative to the total weight of the composition, a selected surfactant or a mixture of surfactants, of which the HLB (hydrophilic-lipophilic balance) value is between 7 and 20, limits included.
